(19) United States
(12) Patent Application Publication
(10) Pub. No.: US 2005/0221170 A1
(43) Pub. Date: Oct. 6, 2005

(54) Non-aqueous electrolyte secondary battery

(75) Inventors: Masanobu Takeuchi, Kobe-shi (JP); Seiji Yoshimura, Kobe-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO Electric Co., Ltd., Moriguchi City (JP)

(21) Appl. No.: 11/090,002

(22) Filed: Mar. 28, 2005

(30) Foreign Application Priority Data
Mar. 30, 2004 (JP) 2004-100864
Feb. 23, 2005 (JP) 2005-047671

(51) Int. Cl. H01M 6/00; H01M 10/00

(52) U.S. Cl. 429/122; 429/209; 429/231.6; 429/223; 429/224

(57) ABSTRACT

A non-aqueous electrolyte secondary battery includes a positive electrode, a negative electrode, and a non-aqueous electrolyte, and the negative electrode contains a conductive agent and a negative electrode active material including a lithium titanium oxide. The conductive agent in the negative electrode includes graphitized vapor grown carbon fiber having a lattice constant C₀ along a stacking direction of from 6.7 Å to 6.8 Å, as determined by X-ray diffraction.

### RELATED APPLICATIONS

This application claims priority from Japanese Patent Application Nos. 2004-100864 and 2005-47671, which are hereby incorporated by reference.

### BACKGROUND OF THE INVENTION

1. Field of the Invention

The present invention relates to non-aqueous electrolyte secondary batteries. More particularly, the invention relates to a non-aqueous electrolyte secondary battery employing a negative electrode containing a negative electrode active material comprising a lithium titanium oxide, such as Li₄Ti₅O₂, that is configured to prevent degradation in battery performance when the non-aqueous electrolyte secondary battery is consecutively charged at a constant voltage for a long period of time with a very small current.

2. Description of Related Art

In recent years, a non-aqueous electrolyte secondary battery, which employs a non-aqueous electrolyte solution and has a high electromotive force, has been widely used as a new type of secondary battery that achieves high power and high energy density.

This type of non-aqueous electrolyte secondary battery has been used as a power source for backing up memory data in mobile devices, in addition to use in a primary power source of mobile devices. In recent years, power sources for memory backup have been demanded to have higher energy densities as primary power sources in mobile devices tend to have higher energy densities.

The positive electrode active materials used for the non-aqueous electrolyte secondary battery are lithium transition metal composite oxides such as lithium cobalt oxide, lithium nickel oxide, and lithium manganese oxide having a spinel structure. The negative electrode active materials used include metallic lithium, lithium alloys, carbon materials capable of intercalating and deintercalating lithium ions, lithium titanium oxides, and the like.

It has been disclosed that a non-aqueous electrolyte secondary battery using a lithium titanium oxide comprising Li₄Ti₅O₁₂ as the negative electrode active material shows good charge-discharge cycle performance (see Japanese Published Unexamined Patent Application No. 7-335261). It has also been disclosed that a non-aqueous electrolyte secondary battery in which the negative electrode uses a lithium titanium oxide as noted above and carbon fibers offers good rate characteristics and power characteristics as well as durability (see Japanese Published Unexamined Patent Application No. 2001-196060).

A problem with such non-aqueous electrolyte secondary batteries as described above, which use a lithium titanium oxide as the negative electrode active material, has been that, although the non-aqueous electrolyte secondary batteries present particular problems when used as the primary power source of mobile devices, they cause degradation in battery performance when used as a power source for memory backup with a working voltage of about 3.0 V.

It is believed that the reason is as follows. When a non-aqueous electrolyte secondary battery as described above is used as the primary power source for mobile devices, the negative electrode is charged to about 0.1 V versus lithium metal during the charge and thereby a surface film having a good ionic conductivity forms on the surface of the negative electrode. This surface film suppresses a reaction between the negative electrode and the non-aqueous electrolyte and prevents decomposition of the non-aqueous electrolyte or destruction of the structure of the negative electrode. On the other hand, when the non-aqueous electrolyte secondary battery is used for a power supply for the purpose of memory backup with a working voltage of about 3.0 V, the battery is charged at a constant voltage of about 3.0 V for a long period of time with a very small current of about 1 μA to 5 μA, and the negative electrode is charged only to about 0.8 V versus lithium metal. This means that the surface film as noted above does not form on the surface of the negative electrode and consequently a reaction occurs between the negative electrode and the non-aqueous electrolyte, causing decomposition of the non-aqueous electrolyte or destruction of the structure of the negative electrode.

### BRIEF SUMMARY OF THE INVENTION

It is an object of the present invention is to prevent degradation in battery performance of a non-aqueous electrolyte secondary battery having a negative electrode that employs a negative electrode active material comprising a lithium titanium oxide such as Li₄Ti₅O₁₂ even when the battery is charged at a constant voltage of about 3.0 V for a long period of time with a very small current of about 1 μA to 5 μA, so that the battery can be suitably used as a power source for memory backup at about 3.0 V.

The present invention provides a non-aqueous electrolyte secondary battery comprising a positive electrode, a negative electrode, and a non-aqueous electrolyte, the negative electrode having a negative electrode active material containing a lithium titanium oxide and a conductive agent, wherein the conductive agent in the negative electrode comprises graphitized vapor grown carbon fiber having a lattice constant C₀ along a stacking direction, as determined by X-ray diffraction, of from 6.7 Å to 6.8 Å.

The non-aqueous electrolyte secondary battery of the present invention uses, as a conductive agent, a graphitized vapor grown carbon fiber material having a lattice constant C₀ along a stacking direction determined by X-ray diffraction of from 6.7 Å to 6.8 Å in the negative electrode using a lithium titanium oxide as the negative electrode active material. It is believed that, although the cause is not fully understood, the use of the above-noted conductive agent as a conductive agent stabilizes the negative electrode in a charged state and suppresses a reaction between the negative electrode and the non-aqueous electrolyte, thereby preventing decomposition of the non-aqueous electrolyte or destruction of the structure of the negative electrode. The reason why the graphitized vapor grown carbon fiber needs to have a lattice constant C₀ along a stacking direction of 6.7 Å to 6.8 Å as determined by X-ray diffraction is that, if the lattice constant C₀ is greater than 6.8 Å, solvated Li ions enter the carbon material, causing a side reaction such that decomposes the solvent or destruction of the structure of the graphitized vapor grown carbon fiber. The reason why the lattice constant C₀ is restricted to be 6.7 Å or greater is that the lattice constant C₀ is theoretically 6.7 Å or greater.

As a consequence, with the non-aqueous electrolyte secondary battery of the present invention, the battery performance degradation is prevented even when charging is conducted at a constant voltage of about 3.0 V for a long period of time with a very small current of about 1 μA to 5 μA, and the battery can be suitably used as a power source for memory backup with a working voltage of about 3.0 V.

These and other objects, advantages and features of the invention will become apparent from the following description thereof taken in conjunction with the accompanying drawings which illustrate specific embodiments of the invention.

### BRIEF DESCRIPTION OF THE DRAWINGS

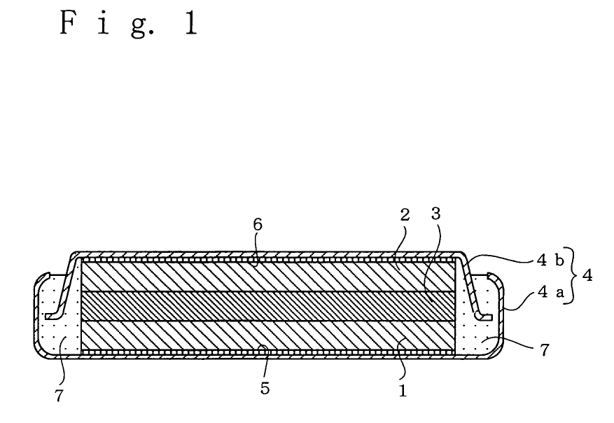

The FIG. 1 is a schematic cross-sectional view of a non-aqueous electrolyte secondary battery fabricated for Examples and Comparative Examples of the present invention.

### DETAILED DESCRIPTION OF THE PREFERRED EMBODIMENTS

Hereinbelow, preferred embodiments of a non-aqueous electrolyte secondary battery are described in further detail. It should be construed, however, that the non-aqueous electrolyte secondary battery according to the present invention is not limited to the following preferred embodiments thereof, but various changes and modifications are possible unless such changes and variations depart from the scope of the invention as defined by the appended claims.

In the non-aqueous electrolyte secondary battery according to the present invention, Li₄Ti₅O₁₂ or the like may be used as the lithium titanium oxide used for the negative electrode active material of the negative electrode; in particular, it is preferable to use Li₄Ti₅O₁₂ that has voids inside and has an increased specific surface area, in order to enhance the charge-discharge characteristics of the negative electrode.

In the non-aqueous electrolyte secondary battery according to the present invention, the graphitized vapor grown carbon fiber material having a lattice constant C₀ in the stacking direction of from 6.7 Å to 6.8 Å as determined by X-ray diffraction, which is used for a conductive agent in the negative electrode, should preferably have a ratio (La/Lc) within the range of from 4 to 6, wherein the ratio (La/Lc) is the crystallite size La along the a-axis orientation with respect to the crystallite size Lc along the c-axis orientation. If the ratio La/Lc is less than 4, a side reaction with the non-aqueous electrolyte tends to occur easily in the c-plane of the graphitized vapor grown carbon fiber, so there is a risk of decomposition of the non-aqueous electrolyte or destruction of the structure of the negative electrode. On the other hand, if the ratio La/Lc exceeds 6, the formability of the negative electrode degrades. Preferably, the ratio La/Lc is 5 or less.

It is preferable that the above-noted graphitized vapor grown carbon fiber have a specific surface area within the range of from 10 m²/g to 20 m²/g. The reason is that when the specific surface area is less than 10 m²/g, sufficient conductivity may not be attained, whereas when the specific surface area is greater than 20 m²/g, the graphitized vapor grown carbon fiber may cause a reaction with the non-aqueous electrolyte.

The above-noted graphitized vapor grown carbon fiber is relatively hard and has elasticity. Accordingly, in producing a negative electrode using the negative electrode mixture that contains a conductive agent, a binder agent, and a negative electrode active material comprising a lithium titanium oxide, if the amount of the graphitized vapor grown carbon fiber is too large, the negative electrode becomes brittle, degrading the strength; on the other hand, if the amount of the graphitized vapor grown carbon fiber is too small, sufficient conductivity cannot be attained. Therefore, it is preferable that the amount of graphitized vapor grown carbon fiber in the negative electrode mixture be within the range of from 3 mass % to 8 mass % when producing a negative electrode using the negative electrode mixture that contains a conductive agent, a binder agent, and a negative electrode active material comprising a lithium titanium oxide.

Moreover, in order to increase the strength of the negative electrode while maintaining its conductivity, it is preferable that a carbon material other than graphitized vapor grown carbon fiber be added as a conductive agent for the negative electrode in addition to the above-noted graphitized vapor grown carbon fiber. With this carbon material other than the graphitized vapor grown carbon fiber as well, if the lattice constant C₀ in a stacking direction is greater than 6.8 Å as determined by X-ray diffraction, solvated Li ions enter the carbon material, causing such a side reaction that decomposes the solvent or destruction the structure of the carbon material. Therefore, it is necessary that the additional carbon material also have a lattice constant C₀ in a stacking direction of from 6.7 Å to 6.8 Å as determined by X-ray diffraction.

Moreover, in cases where another carbon material other than graphitized vapor grown carbon fiber is added in addition to the graphitized vapor grown carbon fiber, such advantageous effects as attained when using the graphitized vapor grown carbon fiber as described above cannot be achieved if the amount of the graphitized vapor grown carbon fiber is too small. On the other hand, if the amount of the carbon material other than the graphitized vapor grown carbon fiber is too small, the negative electrode becomes brittle, making it difficult to suppress reduction in the strength. Therefore, it is preferable that the mass ratio of the graphitized vapor grown carbon fiber and the carbon material other than the graphitized vapor grown carbon fiber be within the range of 4:1 to 1:9.

In addition, any commonly-used known binder agent may be used as a binder agent in producing a negative electrode using the negative electrode mixture containing a conductive agent, a binder agent, and a negative electrode active material comprising a lithium titanium oxide. In particular, when Li₄Ti₅O₁₂ having voids therein and an increased specific surface area is used to increase the charge-discharge characteristics of the negative electrode, it is preferable to use fluorinated ethylene propylene as the binder agent in order to increase the flowability of the negative electrode mixture and thereby improve the formability.

Further, in the non-aqueous electrolyte secondary battery according to the present invention, the positive electrode active material in the positive electrode may be any positive electrode active material that is conventionally known.

The use of a lithium transition metal composite oxide represented by the formula LiMnₓNi_{y}Co_{z}O₂ (where x+y+z=1, 0×0.5, 0 y 1, and 0 z 1) as the positive electrode active material in combination with the above-noted negative electrode using a lithium titanium oxide for the negative electrode active material makes it possible to obtain a non-aqueous electrolyte secondary battery with a working voltage of about 2.3 V to 3.2 V.

Further, in using the lithium transition metal composite oxide represented by the formula LiMnₓNi_{y}Co_{z}O₂ (where x+y+z=1, 0×0.5, 0 y 1, and 0 z 1) as the positive electrode active material in the positive electrode, the mass ratio of the negative electrode active material to the positive electrode active material should preferably be 0.57 to 0.95. This allows the end-of-charge voltage in the negative electrode to become about 0.8 V versus lithium metal when the battery is charged at a constant voltage of about 3.0 V, which makes it possible to suppress decomposition of the non-aqueous electrolyte resulting from the reaction with the negative electrode and destruction of the structure of the negative electrode. At the same time, it prevents the end-of-charge voltage in the positive electrode from rising too high, which makes it possible to suppress such change in quality of the positive electrode active material as leading to destruction of the structure of the positive electrode and such a reaction between the positive electrode and the non-aqueous electrolyte as causing decomposition of the non-aqueous electrolyte.

In particular, the mass ratio of the negative electrode active material to the positive electrode active material is preferably from 0.57 to 0.85 when using LiCoO₂ as the positive electrode active material, or the mass ratio of the negative electrode active material to the positive electrode active material is preferably from 0.70 to 0.95 when using LiMn_{1/3}Ni_{1/3}Co_{1/3}O₂ as the positive electrode active material. This restricts the potential of the positive electrode at the end of charge to be 4.2 V or less versus lithium metal, which makes it possible to prevent the positive electrode active material from such change in quality as to destruct the structure of the positive electrode and suppress such a reaction between the positive electrode and the non-aqueous electrolyte as to decompose the non-aqueous electrolyte.

Moreover, the positive electrode may be prepared using a positive electrode mixture in which a positive electrode active material as described above is mixed with a conductive agent, such as acetylene black or carbon black, and a binder agent, such as polytetrafluoroethylene or poly(vinylidene fluoride).

Furthermore, in the in the non-aqueous electrolyte secondary battery according to the present invention, any known non-aqueous solvent that has been conventionally used may be employed as a non-aqueous solvent to be used for the non-aqueous electrolyte. Particularly preferable is a mixed solvent in which a cyclic carbonate and a chain carbonate are mixed. Examples of the cyclic carbonate include ethylene carbonate, propylene carbonate, butylene carbonate, and vinylene carbonate. Examples of the chain carbonate include dimethyl carbonate, methyl ethyl carbonate, and diethyl carbonate. Alternatively, as the non-aqueous solvent, it is possible to use -butyrolactone or a mixed solvent in which -butyrolactone is mixed with a cyclic carbonate. Generally, a cyclic carbonate tends to decompose at a high potential; therefore, it is preferable that the proportion of cyclic carbonate in the non-aqueous solvent be within the range of from 10 volume % to 50 volume %, or more preferably, within the range of from 10 volume % to 30 volume %. In particular, the use of ethylene carbonate as a cyclic carbonate improves battery's storage performance and is therefore preferable.

In the non-aqueous electrolyte, any known solute that has conventionally been used may be employed as a solute to be dissolved in the non-aqueous solvent. Examples include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, which may be used either alone or in combination. The use of LiPF₆ as the solute causes a surface film originating from the decomposition of the LiPF₆ to form on the surface of the current collector made of aluminum, which is commonly used for the positive electrode, when the battery is charged at a high charge voltage, and consequently prevents the aluminum current collector from being dissolved.

Hereinbelow, examples will be specifically described of the non-aqueous electrolyte secondary battery according to the present invention, and it will be demonstrated by the comparison with comparative examples that the non-aqueous electrolyte secondary batteries in the examples are capable of preventing degradation in battery performance when charged at a constant voltage of about 3.0 V for a long period of time with a very small current. It should be construed that the non-aqueous electrolyte secondary battery according to the present invention is not limited to those illustrated in the following examples, but various changes and modifications may be made unless such changes and variations depart from the scope of the invention as defined in the appended claims.

### EXAMPLE A1

In Example A1, a flat, coin-shaped non-aqueous electrolyte secondary battery as illustrated in FIG. 1 was fabricated using a positive electrode, a negative electrode, and a non-aqueous electrolyte that were prepared in the following manner.

Preparation of Positive Electrode

A positive electrode was prepared as follows. LiCoO₂ was used as the positive electrode active material. 85 parts by mass of that LiCoO₂ powder was mixed together with 5 parts by mass of acetylene black and 5 parts by mass of artificial graphite having a specific surface area of 300 m²/g as conductive agents, as well as 5 parts by mass of powder of poly(vinylidene fluoride) as a binder agent, to prepare a positive electrode mixture. Then, the positive electrode mixture was press formed to prepare a positive electrode in a pellet form of diameter 4 mm, thickness 0.75 mm, and mass 30 mg. The amount of LiCoO₂ in this positive electrode was 25.5 mg.

Preparation of Negative Electrode

A negative electrode was prepared as follows. Li₄Ti₅O₁₂ was used as the negative electrode active material and graphitized vapor grown carbon fiber having a specific surface area of 15.8 m²/g was used as a conductive agent. Here, the physical properties of the graphitized vapor grown carbon fiber were measured using RINT2200 (a tradename for an X-ray diffractometer made by Rigaku Corp.), which were determined as C₀=6.74 Å, Lₐ=900 Å, and L_{c}=200Å.

Then, 90 parts by mass of powder of the above-noted Li₄Ti₅O₁₂ was mixed together with 5 parts by mass of powder of the above-noted graphitized vapor grown carbon fiber and 5 parts by mass of powder of poly(vinylidene fluoride) as a binder agent to prepare a negative electrode mixture. The negative electrode mixture was then press formed to prepare a negative electrode in a pellet form of diameter 4 mm, thickness 0.80 mm, and mass 23 mg. The amount of the Li₄Ti₅O₁₂ in this negative electrode was 20.7 mg.

Preparation of Non-aqueous Electrolyte Solution

A non-aqueous electrolyte solution was prepared by dissolving lithium hexafluorophosphate LiPF₆ as a solute at a proportion of 1 mol/L in a mixed solvent in which ethylene carbonate, which is a cyclic carbonate, and diethyl carbonate, which is a chain carbonate, were mixed at a volume ratio of 3:7.

Preparation of Battery

A battery was fabricated as follows. As illustrated in FIG. 1, a separator 3 made of nonwoven polypropylene fabric in which the above-described non-aqueous electrolyte was impregnated was interposed between a positive electrode 1 and a negative electrode 2, which were prepared in the above-described manner, and these components were accommodated in a battery case 4 made of a positive electrode can 4a and a negative electrode can 4b. The positive electrode 1 was connected to the positive electrode can 4a via a positive electrode current collector 5, while the negative electrode 2 was connected to the negative electrode can 4b via a negative electrode current collector 6. The positive electrode can 4a and the negative electrode can 4b were electrically insulated with an insulative packing 7 made of polypropylene. Thus, a flat, coin-shaped lithium secondary battery having a diameter of 6 mm and a thickness of 2.1 mm was obtained.

### EXAMPLE A2

In Example A2, a non-aqueous electrolyte secondary battery of Example A2 was fabricated in the same manner as Example A1 except that the type of conductive agent was changed from that of the negative electrode of Example A1.

The conductive agent of the negative electrode used in Example A2 was graphitized vapor grown carbon fiber with a specific surface area of 15.3 m²/g, C₀=6.80 Å, Lₐ=900 Å, and L_{c}=200 Å.

### COMPARATIVE EXAMPLES a1 TO a5

In Comparative Examples a1 to a5, non-aqueous electrolyte secondary batteries of Comparative Examples a1 to a5 were fabricated in the same manner as in Example A1 except that the types of conductive agents used for the negative electrodes were changed from that used in Example A1.

The conductive agents used for the negative electrodes here were as follows; Comparative Example a1 used graphitized vapor grown carbon fiber (C₀=6.83 Å, Lₐ=700 Å, L_{c}=150 Å), Comparative Example a2 used pitch-based graphite fiber (C₀=6.78 Å, Lₐ=30 Å, L_{c}=50 Å), Comparative Example a3 used natural graphite (C₀=6.71 Å, Lₐ=100 Å, L_{c}=70 Å), Comparative Example a4 used artificial graphite (C₀=6.72 Å, Lₐ=300 Å, L_{c}=300 Å), and Comparative Example a5 used carbon black (C₀=7.00 Å, Lₐ=50Å, L_{c}=36 Å).

### COMPARATIVE EXAMPLES a6 TO a12

In Comparative Examples a6 to a12, non-aqueous electrolyte secondary batteries of Comparative Examples a6 to a12 were fabricated in the same manner as in Example A1 except that artificial graphite was used as the negative electrode active material, the amount of the artificial graphite in the negative electrodes was 15.0 mg, and the negative electrodes employed the following conductive agents.

The conductive agents in the negative electrodes here were as follows; Comparative Example a6 used the same graphitized vapor grown carbon fiber as that of Example A1 (C₀=6.74 Å), Comparative Example a7 used the same graphitized vapor grown carbon fiber as that of Example A2 (C₀=6.80 Å), Comparative Example a8 used the same graphitized vapor grown carbon fiber as that of Comparative Example a1 (C₀=6.83 Å), Comparative Example a9 used the same pitch-based graphite fiber as that of Comparative Example a2 (C₀=6.78 Å), Comparative Example a10 used the same natural graphite as that of Comparative Example a3 (C₀=6.71 Å), Comparative Example a11 used the same artificial graphite as that of Comparative Example a4 (C₀=6.72 Å), and Comparative Example a12 used the same carbon black as that of Comparative Example a5 (C₀=7.00 Å).

### COMPARATIVE EXAMPLES a13 TO a19

In Comparative Examples a13 to a19, non-aqueous electrolyte secondary batteries of Comparative Examples a13 to a19 were fabricated in the same manner as in Example A1 except that niobium pentoxide was used as the negative electrode active material, the amount of the niobium pentoxide in the negative electrode was 21.6 mg, and the negative electrodes employed the following conductive agents.

The conductive agents in the negative electrodes here were as follows; Comparative Example a13 used the same graphitized vapor grown carbon fiber as that of Example A1 (C₀=6.74 Å), Comparative Example a14 used the same graphitized vapor grown carbon fiber as that of Example A2 (C₀=6.80 Å), Comparative Example a15 used the same graphitized vapor grown carbon fiber as that of Comparative Example a1 (C₀=6.83 Å), Comparative Example a16 used the same pitch-based graphite fiber as that of Comparative Example a2 (C₀=6.78 Å), Comparative Example a17 used the same natural graphite as that of Comparative Example a3 (C₀=6.71 Å), Comparative Example a18 used the same artificial graphite as that of Comparative Example a4 (C₀=6.72 Å), and Comparative Example a19 used the same carbon black as that of Comparative Example a5 (C₀=7.00Å).

### COMPARATIVE EXAMPLES a20 TO a26

In Comparative Examples a20 to a26, non-aqueous electrolyte secondary batteries of Comparative Examples a20 to a26 were fabricated in the same manner as in Example A1 except that molybdenum dioxide was used as the negative electrode active material, the amount of the molybdenum dioxide in the negative electrode was 27.5 mg, and the negative electrodes employed the following conductive agents.

The conductive agents used for the negative electrodes here were as follows; Comparative Example a20 used the same graphitized vapor grown carbon fiber as that of Example A1 (C₀=6.74 Å), Comparative Example a21 used the same graphitized vapor grown carbon fiber as that of Example A2 (C₀=6.80 Å), Comparative Example a22 used the same graphitized vapor grown carbon fiber as that of Comparative Example a1 (C₀=6.83 Å), Comparative Example a23 used the same pitch-based graphite fiber as that of Comparative Example a2 (C₀=6.78 Å), Comparative Example a24 used the same natural graphite as that of Comparative Example a3 (C₀=6.71 Å), Comparative Example a25 used the same artificial graphite as that of Comparative Example a4 (C₀=6.72 Å), and Comparative Example a26 used the same carbon black as that of Comparative Example a5 (C₀=7.00 Å).

In each of the non-aqueous electrolyte secondary batteries of Examples A1 and A2 and Comparative Examples a1 to a26, the amounts of the positive electrode active material and the negative electrode active material were controlled as described above, whereby, when setting the end-of-charge voltage at 3.0 V, the potential of the positive electrode was about 4.2 V versus lithium metal and the potential of the negative electrode was about 1.2 V versus lithium metal.

The non-aqueous electrolyte secondary batteries of Examples A1 and A2, and Comparative Examples a1 to a26 fabricated in the above-described manner were charged at a constant current of 50 μA at room temperature until the battery voltage reached 3.0 V, and thereafter, a constant voltage charge at 3.0 V was performed consecutively for 60 days in an atmosphere at 60° C. After the constant voltage charge, the internal resistances of the non-aqueous electrolyte secondary batteries were measured. The results are shown in Table 1 below.

TABLE 1

| | Negative electrode | Conductive agent in negative electrode | | Internal resistance |
|---|---|---|---|---|
| | active material | Type | C₀(Å) | ( ) |
| Ex. A1 | Li₄Ti₅O₁₂ | Graphitized vapor grown carbon fiber | 6.74 | 380 |
| Ex. A2 | Li₄Ti₅O₁₂ | Graphitized vapor grown carbon fiber | 6.80 | 680 |
| Comp. Ex. a1 | Li₄Ti₅O₁₂ | Graphitized vapor grown carbon fiber | 6.83 | 8780 |
| Comp. Ex. a2 | Li₄Ti₅O₁₂ | Pitch-based carbon fiber | 6.78 | 10890 |
| Comp. Ex. a3 | Li₄Ti₅O₁₂ | Natural graphite | 6.71 | 7380 |
| Comp. Ex. a4 | Li₄Ti₅O₁₂ | Artificial graphite | 6.72 | 7560 |
| Comp. Ex. a5 | Li₄Ti₅O₁₂ | Carbon black | 7.00 | 1 M or greater |
| Comp. Ex. a6 | Artificial graphite | Graphitized vapor grown carbon fiber | 6.74 | 10890 |
| Comp. Ex. a7 | Artificial graphite | Graphitized vapor grown carbon fiber | 6.80 | 10140 |
| Comp. Ex. a8 | Artificial graphite | Graphitized vapor grown carbon fiber | 6.83 | 10340 |
| Comp. Ex. a9 | Artificial graphite | Pitch-based carbon fiber | 6.78 | 12030 |
| Comp. Ex. a10 | Artificial graphite | Natural graphite | 6.71 | 8930 |
| Comp. Ex. a11 | Artificial graphite | Artificial graphite | 6.72 | 9120 |
| Comp. Ex. a12 | Artificial graphite | Carbon black | 7.00 | 1 M or greater |
| Comp. Ex. a13 | Niobium pentoxide | Graphitized vapor grown carbon fiber | 6.74 | 3140 |
| Comp. Ex. a14 | Niobium pentoxide | Graphitized vapor grown carbon fiber | 6.80 | 4850 |
| Comp. Ex. a15 | Niobium pentoxide | Graphitized vapor grown carbon fiber | 6.83 | 9210 |
| Comp. Ex. a16 | Niobium pentoxide | Pitch-based carbon fiber | 6.78 | 10590 |
| Comp. Ex. a17 | Niobium pentoxide | Natural graphite | 6.71 | 8070 |
| Comp. Ex. a18 | Niobium pentoxide | Artificial graphite | 6.72 | 8230 |
| Comp. Ex. a19 | Niobium pentoxide | Carbon black | 7.00 | 1 M or greater |
| Comp. Ex. a20 | Molybdenum dioxide | Graphitized vapor grown carbon fiber | 6.74 | 4960 |
| Comp. Ex. a21 | Molybdenum dioxide | Graphitized vapor grown carbon fiber | 6.80 | 5430 |
| Comp. Ex. a22 | Molybdenum dioxide | Graphitized vapor grown carbon fiber | 6.83 | 9532 |
| Comp. Ex. a23 | Molybdenum dioxide | Pitch-based carbon fiber | 6.78 | 10460 |
| Comp. Ex. a24 | Molybdenum dioxide | Natural graphite | 6.71 | 8560 |
| Comp. Ex. a25 | Molybdenum dioxide | Artificial graphite | 6.72 | 8760 |
| Comp. Ex. a26 | Molybdenum dioxide | Carbon black | 7.00 | 1 M or greater |

The results demonstrate that the non-aqueous electrolyte secondary batteries of Examples A1 and A2, which used a lithium titanium oxide Li₄Ti₅O₁₂ as the negative electrode active material and the graphitized vapor grown carbon fiber having a lattice constant C₀ of 6.8 Å or less as a conductive agent of the negative electrode, offered lower internal resistances than those of the non-aqueous electrolyte secondary batteries of Comparative Examples a1 to a26. This means that the battery performance degradation was suppressed when the batteries were charged at a constant voltage of 3.0 V for a long period of time. This was believed to be because, by adding the graphitized vapor grown carbon fiber having a lattice constant C₀ of 6.80 Å or less as a conductive agent to the negative electrode active material using a lithium titanium oxide Li₄Ti₅O₁₂ as described above, the negative electrode in a charged state was stabilized, and consequently, side reactions such as the reactions between the negative electrode and the non-aqueous electrolyte were prevented.

The non-aqueous electrolyte secondary battery of Comparative Example a1, which used a lithium titanium oxide Li₄Ti₅O₁₂ as the negative electrode active material and the graphitized vapor grown carbon fiber having a lattice constant C₀ of 6.83 Å as the conductive agent of the negative electrode, showed a large internal resistance. The large internal resistance is believed to be due to the wider gap between the layers of the graphitized vapor grown carbon fiber, which causes solvated Li ions to enter the graphitized vapor grown carbon fiber and thus bring about a side reaction.

Despite the use of the graphitized vapor grown carbon fibers having a lattice constant C₀ of 6.80 Å or less as the conductive agent of the negative electrode, the non-aqueous electrolyte secondary batteries of Comparative Examples a6, a7, a13, a14, a20, and a21, which used artificial graphite, niobium pentoxide, or molybdenum dioxide as the negative electrode active material, showed greater internal resistances than those of the non-aqueous electrolyte secondary batteries of Examples A1 and A2, which used a lithium titanium oxide Li₄Ti₅O₁₂ as the negative electrode active material. These results demonstrate that it is necessary to use a lithium titanium oxide Li₄Ti₅O₁₂ as the negative electrode active material together with the use of a graphitized vapor grown carbon fiber having a lattice constant C₀ of 6.80 Å or less described above as a conductive agent.

Moreover, the non-aqueous electrolyte secondary batteries of Comparative Examples a2 to a5, which used a lithium titanium oxide Li₄Ti₅O₁₂ as the negative electrode active material along with pitch-based graphite fiber, natural graphite, or artificial graphite having a lattice constant C₀ of 6.80 Å or less as the conductive agent of the negative electrode, also showed greater internal resistances than the non-aqueous electrolyte secondary batteries of Examples A1 and A2, which used the graphitized vapor grown carbon fiber having a lattice constant C₀ of 6.8 Å or less as a conductive agent of the negative electrode. This is probably because the pitch-based graphite fiber, the natural graphite, and the artificial graphite have smaller ratios (La/Lc) of the crystallite size La along the a-axis orientation to the crystallite size Lc along the c-axis orientation than that of the graphitized vapor grown carbon fiber, which can cause a side reaction between the carbon material and the non-aqueous electrolyte on the c-plane more easily.

### EXAMPLES B1 TO B3

In Examples B1 to B3, non-aqueous electrolyte secondary batteries of Examples B1 to B3 were fabricated in the same manner as in Example A1 except that different types of positive electrode active materials from that used in Example A1 were used for the positive electrodes.

The positive electrode active materials used here were as follows; Example B1 used LiNi_{1/3}Mn_{1/3}Co_{1/3}O₂, Example B2 used LiNi_{1/4}Mn_{1/4}Co_{1/2}O₂, and Example B3 used LiNi_{1/6}Mn_{1/6}Co_{2/3}O₂. In each of the non-aqueous electrolyte secondary batteries of Examples B1 to B3 as well, the amounts of the positive electrode active material and the negative electrode active material were adjusted so that the positive electrode potential resulted in about 4.2 V versus lithium metal and the negative electrode potential resulted in about 1.2 V versus lithium metal, when setting the end-of-charge voltage at 3.0 V.

With the non-aqueous electrolyte secondary batteries of Examples B1 to B3 thus fabricated as well, their internal resistances of the non-aqueous electrolyte secondary batteries after the constant voltage charge were measured in the same manner as in Example A1. The results are shown in Table 2 below along with the result for Example A1.

TABLE 2

| | | Conductive agent in | | Internal |
|---|---|---|---|---|
| | Positive electrode | negative electrode | | resistance |
| | active material | Type | C₀(Å) | ( ) |
| Ex. A1 | LiCoO₂ | Graphitized vapor | 6.74 | 380 |
| | | grown carbon fiber | | |
| Ex. B1 | LiNi_{1/3}Mn_{1/3}Co_{1/3}O₂ | Graphitized vapor | 6.74 | 950 |
| | | grown carbon fiber | | |
| Ex. B2 | LiNi_{1/4}Mn_{1/4}Co_{1/2}O₂ | Graphitized vapor | 6.74 | 980 |
| | | grown carbon fiber | | |
| Ex. B3 | LiNi_{1/6}Mn_{1/6}Co_{2/3}O₂ | Graphitized vapor | 6.74 | 1050 |
| | | grown carbon fiber | | |

The results demonstrate that the non-aqueous electrolyte secondary batteries of Examples B1 to B3, which used LiNi_{1/3}Mn_{1/3}Co_{1/3}O₂, LiNi_{1/4}Mn_{1/4}Co_{1/2}O₂, or LiNi_{1/6}Mn_{1/6}Co_{2/3}O₂ as the positive electrode active material, also offered lower internal resistances than those of the above-noted non-aqueous electrolyte secondary batteries of Comparative Example a1 to a26, which means that the battery performance degradation in the case where the battery was charged at a constant voltage of 3.0 V for a long period of time was suppressed.

When comparing among the non-aqueous electrolyte secondary batteries of Examples A1 and B1 to B3, the non-aqueous electrolyte secondary battery of Example A1, which used LiCoO₂ as the positive electrode active material, provided the lowest internal resistance.

### EXAMPLE C1

Example C1 used a positive electrode, a negative electrode, and a non-aqueous electrolyte that were fabricated in the following manner.

Preparation of Positive Electrode

A positive electrode was prepared as follows. LiCoO₂ was used as the positive electrode active material. In a methyl pyrrolidone solvent, 85 parts by mass of that LiCoO₂ powder was mixed together with 5 parts by mass of acetylene black and 5 parts by mass of artificial graphite having a specific surface area of 300 m²/g as conductive agents, as well as 5 parts by mass of powder of poly(vinylidene fluoride) as a binder agent. The mixture was dried, then pulverized, and classified by passing it through a mesh. Thus, a positive electrode mixture was prepared. Then, 18.2 mg of the positive electrode mixture was press formed, and thus a positive electrode in a pellet form was prepared of density 3.20 g/cm³, diameter 4.16 mm, and thickness 0.42 mm. The amount of LiCoO₂ in this positive electrode was 15.5 mg.

Preparation of Negative Electrode

A negative electrode was prepared as follows. Li₄Ti₅O₁₂ was used as the negative electrode active material, and the same graphitized vapor grown carbon fiber as that of Example 1 (C₀=6.74 Å) was used as the conductive agent.

Then, 90 parts by mass of powder of the above-noted Li₄Ti₅O₁₂, 5 parts by mass of powder of the above-noted graphitized vapor grown carbon fiber, and 5 parts by mass of powder of poly(vinylidene fluoride) as a binder agent were mixed together in a methyl pyrrolidone solvent. The mixture was dried, then pulverized, and classified by passing it through a mesh, to prepare a negative electrode mixture. Then, 14.3 mg of the negative electrode mixture was press formed to prepare a negative electrode in a pellet form of density 2.17 g/cm³, diameter 4.16 mm, and thickness 0.48 mm. The amount of the Li₄Ti₅O₁₂ in this negative electrode was 12.9 mg.

Preparation of Non-Aqueous Electrolyte Solution

A non-aqueous electrolyte solution was prepared by dissolving lithium hexafluorophosphate LiPF₆ as a solute at a proportion of 1 mol/L in a mixed solvent in which ethylene carbonate, which is a cyclic carbonate, and diethyl carbonate, which is a chain carbonate, were mixed at a volume ratio of 3:7.

Using the positive electrode, the negative electrode, and the non-aqueous electrolyte that were prepared in the above-described manner, a flat, coin-shaped lithium secondary battery as shown in FIG. 1 was obtained in the same manner as in Example A1. This non-aqueous electrolyte secondary battery of Example C1 had a diameter of 6 mm and a thickness of 1.4 mm.

### EXAMPLE C2

In Example C2, a non-aqueous electrolyte secondary battery of Example C2 was fabricated in the same manner as in Example C1 except that the type of conductive agent used for the negative electrode was changed from that of Example C1.

In Example C2 here, the same graphitized vapor grown carbon fiber (C₀=6.80 Å) as that of Example A2 was used as the conductive agent of the negative electrode.

### COMPARATIVE EXAMPLES c1 TO c5

In Comparative Examples c1 to c5, non-aqueous electrolyte secondary batteries of Comparative Examples c1 to c5 were fabricated in the same manner as in Example C1 except that the types of conductive agents used for the negative electrodes were changed from that of Example C1.

The conductive agents used in the negative electrodes here were as follows; Comparative Example c1 used the same graphitized vapor grown carbon fiber as that of Comparative Example a1 (C₀=6.83 Å), Comparative Example c2 used the same pitch-based graphite fiber as that of Comparative Example a2 (C₀=6.78 Å), Comparative Example c3 used the same natural graphite as that of Comparative Example a3 (C₀=6.71 Å), Comparative Example c4 used the same artificial graphite as that of Comparative Example a4 (C₀=6.72 Å), and Comparative Example c5 used the same carbon black as that of Comparative Example a5 (C₀=7.00 Å).

Each of the non-aqueous electrolyte secondary batteries of Examples C1 and C2, and Comparative Examples c1 to c5 thus fabricated had a mass ratio X of 0.83, the mass ratio X being the ratio of the negative electrode active material Li₄Ti₅O₁₂ to the positive electrode active material LiCoO₂.

Then, each of the non-aqueous electrolyte secondary batteries of Examples C1 and C2, and Comparative Examples c1 to c5 thus fabricated was charged at a constant current of 50 μA at room temperature until the battery voltage reached 3.2 V, and then a constant voltage charge at 3.2V was performed consecutively for 30 days in an atmosphere at 60° C. After the constant voltage charge, the internal resistances of the non-aqueous electrolyte secondary batteries were measured. The results are shown in Table 3 below.

TABLE 3

| | Negative | | | |
|---|---|---|---|---|
| | electrode | Conductive agent in | | Internal |
| | active | negative electrode | | resistance |
| | material | Type | C₀(Å) | ( ) |
| Ex. C1 | Li₄Ti₅O₁₂ | Graphitized vapor | 6.74 | 654 |
| | | grown carbon fiber | | |
| Ex. C2 | Li₄Ti₅O₁₂ | Graphitized vapor | 6.80 | 780 |
| | | grown carbon fiber | | |
| Comp. Ex. c1 | Li₄Ti₅O₁₂ | Graphitized vapor | 6.83 | 3956 |
| | | grown carbon fiber | | |
| Comp. Ex. c2 | Li₄Ti₅O₁₂ | Pitch-based | 6.78 | 2880 |
| | | carbon fiber | | |
| Comp. Ex. c3 | Li₄Ti₅O₁₂ | Natural graphite | 6.71 | 1680 |
| Comp. Ex. c4 | Li₄Ti₅O₁₂ | Artificial graphite | 6.72 | 1860 |
| Comp. Ex. c5 | Li₄Ti₅O₁₂ | Carbon black | 7.00 | 5k or greater |

The results demonstrate that, as with Examples A1, A2 and Comparative Examples a1 to a5, the non-aqueous electrolyte secondary batteries of Examples C1 and C2, which employed a lithium titanium oxide Li₄Ti₅O₁₂ as the negative electrode active material and the graphitized vapor grown carbon fiber having a lattice constant C₀ of 6.8 Å or less as the conductive agent of the negative electrode, offered lower internal resistances than those of the non-aqueous electrolyte secondary batteries of Comparative Examples c1 to c5. This means that the battery performance degradation was suppressed in the case where the battery was charged at a constant voltage of 3.2 V for a long period of time.

### EXAMPLES C1.1 TO C1.3

In Examples C1.1 to C1.3, non-aqueous electrolyte secondary batteries of Examples C1.1 to C1.3 were fabricated in the same manner as in Example C1 except that the amounts of the positive electrode mixtures used for the positive electrodes and the amounts of the negative electrode mixtures used for the negative electrodes were changed from those in Example C1 in order to change the mass ratios X of the negative electrode active material Li₄Ti₅O₁₂ to the positive electrode active material LiCoO₂.

Here, in Example C1.1, the amount of the positive electrode mixture was 19.2 mg, the amount of the negative electrode mixture was 13.5 mg, and the mass ratio X was 0.74. In Example C1.2, the amount of the positive electrode mixture was 21.8 mg, the amount of the negative electrode mixture was 11.8 mg, and the mass ratio X was 0.57. In Example C1.3, the amount of the positive electrode mixture was 23.0 mg, the amount of the negative electrode mixture was 11.0 mg, and the mass ratio X was 0.50.

### EXAMPLES C2.1 TO C2.3

In Examples C2.1 to C2.3, non-aqueous electrolyte secondary batteries of Examples C2.1 to C2.3 were fabricated in the same manner as in Example C2 except that the amounts of the positive electrode mixtures used for the positive electrodes and the amounts of the negative electrode mixture used for the negative electrodes were changed from those in Example C2 in order to change the mass ratios X of the negative electrode active material Li₄Ti₅O₁₂ to the positive electrode active material LiCoO₂.

Here, in Example C2.1, the amount of the positive electrode mixture was 19.2 mg, the amount of the negative electrode mixture was 13.5 mg, and the mass ratio X was 0.74. In Example C2.2, the amount of the positive electrode mixture was 21.8 mg, the amount of the negative electrode mixture was 11.8 mg, and the mass ratio X was 0.57. In Example C2.3, the amount of the positive electrode mixture was 23.0 mg, the amount of the negative electrode mixture was 11.0 mg, and the mass ratio X was 0.50.

### COMPARATIVE EXAMPLES c1.1 TO c5.1

In Comparative Examples c1.1 to c5.1, non-aqueous electrolyte secondary batteries of Comparative Examples c1.1 to c5.1 were fabricated in the same manner as in Comparative Examples c1 to c5 except that the amount of the positive electrode mixture used for the positive electrode was 21.8 mg and the amount of the negative electrode mixture was 11.8 mg so that the mass ratio X became 0.57.

Then, with the non-aqueous electrolyte secondary batteries of Examples C1.1 to C1.3, Examples C2.1 to C2.3, and Comparative Examples c1.1 to c5.1 thus fabricated, their internal resistances after the constant voltage charge were measured in the same manner as in Examples C1 and C2, and Comparative Examples c1 to c5. The results are shown in Table 4 below along with the results for Examples C1 and C2, and Comparative Examples c1 to c5.

TABLE 4

| | | | Negative electrode | |
|---|---|---|---|---|
| | | | active material/ | |
| | | | Positive electrode | Internal |
| | Conductive agent in negative electrode | | active material | resistance |
| | Type | C₀(Å) | X | ( ) |
| Ex. C1 | Graphitized vapor grown carbon fiber | 6.74 | 0.83 | 654 |
| Ex. C1.1 | Graphitized vapor grown carbon fiber | 6.74 | 0.74 | 460 |
| Ex. C1.2 | Graphitized vapor grown carbon fiber | 6.74 | 0.57 | 120 |
| Ex. C1.3 | Graphitized vapor grown carbon fiber | 6.74 | 0.50 | 90 |
| Ex. C2 | Graphitized vapor grown carbon fiber | 6.80 | 0.83 | 780 |
| Ex. C2.1 | Graphitized vapor grown carbon fiber | 6.80 | 0.74 | 520 |
| Ex. C2.2 | Graphitized vapor grown carbon fiber | 6.80 | 0.57 | 154 |
| Ex. C2.3 | Graphitized vapor grown carbon fiber | 6.80 | 0.50 | 105 |
| Comp. Ex. c1 | Graphitized vapor grown carbon fiber | 6.83 | 0.83 | 3956 |
| Comp. Ex. c1.1 | Graphitized vapor grown carbon fiber | 6.83 | 0.57 | 3450 |
| Comp. Ex. c2 | Pitch-based carbon fiber | 6.78 | 0.83 | 2880 |
| Comp. Ex. c2.1 | Pitch-based carbon fiber | 6.78 | 0.57 | 2300 |
| Comp. Ex. c3 | Natural graphite | 6.71 | 0.83 | 1680 |
| Comp. Ex. c3.1 | Natural graphite | 6.71 | 0.57 | 2250 |
| Comp. Ex. c4 | Artificial graphite | 6.72 | 0.83 | 1860 |
| Comp. Ex. c4.1 | Artificial graphite | 6.72 | 0.57 | 2150 |
| Comp. Ex. c5 | Carbon black | 7.00 | 0.83 | 5k or greater |
| Comp. Ex. c5.1 | Carbon black | 7.00 | 0.57 | 5k or greater |

The results demonstrate that as the mass ratio X of the negative electrode active material to the positive electrode active material was less, the internal resistance reduced, in the non-aqueous electrolyte secondary batteries of Examples C1 and C1.1 to C1.3 as well as C2 and C2.1 to C2.3, which employed the graphitized vapor grown carbon fiber having a lattice constant C₀ of 6.8 Å or less as the conductive agent of the negative electrode. In contrast, with the non-aqueous electrolyte secondary batteries of Comparative Examples c1 to c5 and c1.1 to c5.1, the internal resistance was not necessarily lower when the mass ratio X of the negative electrode active material to the positive electrode active material was less.

Furthermore, immediately after the non-aqueous electrolyte secondary batteries of Examples C1 and C1.1 to C1.3 were fabricated as described above, the batteries were charged at a constant current of 50 μA at room temperature until the battery voltage reached 3.2 V and thereafter subjected to an initial charge at a constant voltage of 3.2 V until the current reduced to 5 μA, in order to measure the potentials of the positive electrodes and the negative electrodes versus lithium metal during the initial charge. Further, after the batteries had been subjected to the initial charge as described above, they were discharged at a current of 50 μA until the battery voltage reached 2.0 V, to measure initial discharge capacity Qo. The results are shown in Table 5 below.

Also, the non-aqueous electrolyte secondary batteries of Examples C1 and C1.1 to C1.3 were placed under room temperature and charged at a constant current of 50 μA until the battery voltage reached 3.2 V and thereafter charged at a constant voltage of 3.2 V consecutively for 30 days in an atmosphere at 60° C. Thereafter, the batteries were discharged at a current of 50 μA until the battery voltage became 2.0 V, to measure post-test discharge capacity Qa. Then, percentage of capacity retention was obtained according to the following equation. The results are shown in Table 5 below.
Percentage of capacity retention=(Qa/Qo)×100

TABLE 5

| | Positive electrode | | Potential | | Initial | |
|---|---|---|---|---|---|---|
| | active material/ | Internal | (V: Li/Li⁺) | | discharge | Capacity |
| | Negative electrode | resistance | Positive | Negative | capacity | retention |
| | active material X | ( ) | electrode | electrode | (mAh) | (%) |
| Ex. C1 | 0.83 | 654 | 4.2 | 1.0 | 2.13 | 84 |
| Ex. C1.1 | 0.74 | 460 | 4.1 | 0.9 | 2.02 | 85 |
| Ex. C1.2 | 0.57 | 120 | 4.0 | 0.8 | 1.77 | 86 |
| Ex. C1.3 | 0.50 | 90 | 4.0 | 0.8 | 1.64 | 86 |

The results show that the potentials of the positive electrode were 4.2 V or less versus lithium metal during the initial charge in all the non-aqueous electrolyte secondary batteries of Examples C1 and C1.1 to C1.3.

Moreover, the initial discharge capacity reduced as the mass ratio X of the negative electrode active material Li₄Ti₅O₁₂ to the positive electrode active material LiCoO₂ became less. Accordingly, it is preferable that the mass ratio X of the negative electrode active material to the positive electrode active material be within the range of from 0.85 to 0.57 to reduce the internal resistance and at the same time obtain a sufficient battery capacity, when using LiCoO₂ as the positive electrode active material.

### EXAMPLES D1 to D5

In Examples D1 to D5, non-aqueous electrolyte secondary batteries of Examples D1 to D5 were fabricated in the same manner as in Example C1 except that the positive electrode active material in the positive electrode of Example C1 was changed to LiNi_{1/3}Mn_{1/3}Co_{1/3}O₂, and the amounts of the positive electrode mixtures employing this positive electrode active material and the amounts of the negative electrode mixtures used for the negative electrodes were changed in order to vary the mass ratios X of the negative electrode active material Li₄Ti₅O₁₂ to the positive electrode active material LiNi_{1/3}Mn_{1/3}Co_{1/3}O₂.

Here, in Example D1, the amount of the positive electrode mixture was 16.4 mg and the amount of the negative electrode mixture was 15.4 mg, so that the mass ratio X was 0.99. In Example D2, the amount of the positive electrode mixture was 16.9 mg and the amount of the negative electrode mixture was 15.1 mg, so that the mass ratio X was 0.95. In Example D3, the amount of the positive electrode mixture was 17.9 mg and the amount of the negative electrode mixture was 14.4 mg, so that the mass ratio X was 0.85. In Example D4, the amount of the positive electrode mixture was 19.8 mg and the amount of the negative electrode mixture was 13.1 mg, so that the mass ratio X was 0.70. In Example D5, the amount of the positive electrode mixture was 21.8 mg and the amount of the negative electrode mixture was 11.8 mg, so that the mass ratio X was 0.57.

Then, with the non-aqueous electrolyte secondary batteries of Examples D1 to D5, measurements were conducted for each of the non-aqueous electrolyte secondary batteries to obtain the internal resistance after constant voltage charge, the potentials of the positive electrode and negative electrode versus lithium metal during initial charge, the initial discharge capacity Qo, and the percentage of capacity retention after the test, in the same manner as in the non-aqueous electrolyte secondary batteries of Examples C1 and C1.1 to C1.3. The results are shown in Table 6 below.

TABLE 6

| | Positive electrode | | Potential | | Initial | |
|---|---|---|---|---|---|---|
| | active material/ | Internal | (V: Li/Li⁺) | | discharge | Capacity |
| | Negative electrode | resistance | Positive | Negative | capacity | retention |
| | active material X | ( ) | electrode | electrode | (mAh) | (%) |
| Ex. D1 | 0.99 | 1853 | 4.3 | 1.1 | 2.18 | 75 |
| Ex. D2 | 0.95 | 1010 | 4.2 | 1.0 | 2.13 | 83 |
| Ex. D3 | 0.85 | 850 | 4.1 | 0.9 | 2.03 | 82 |
| Ex. D4 | 0.70 | 145 | 4.0 | 0.8 | 1.86 | 80 |
| Ex. D5 | 0.57 | 230 | 3.9 | 0.7 | 1.67 | 80 |

The results demonstrate that in the case of using LiNi_{1/3}Mn_{1/3}Co_{1/3}O₂ as the positive electrode active material, the non-aqueous electrolyte secondary batteries of Examples D2 to D5, in which the mass ratios X of the negative electrode active material Li₄Ti₅O₁₂ to the positive electrode active material LiNi_{1/3}Mn_{1/3}Co_{1/3}O₂ were set at 0.95 or less, offered a positive electrode potential 4.2 V or less versus lithium metal during the initial charge, and at the same time, the internal resistance in each of the non-aqueous electrolyte secondary batteries after the constant voltage charge was greatly lower than that of the non-aqueous electrolyte secondary battery of Example D1, in which the mass ratio X was 0.99. On the other hand, the initial discharge capacity reduced as the mass ratio X of the negative electrode active material to the positive electrode active material became less.

This indicates that it is preferable that the mass ratio X of the negative electrode active material Li₄Ti₅O₁₂ to the positive electrode active material LiNi_{1/3}Mn_{1/3}Co_{1/3}O₂ be set within the range of from 0.95 to 0.70 in order to reduce the internal resistance and at the same time obtain a sufficient battery capacity when using LiNi_{1/3}Mn_{1/3}Co_{1/3}O₂ as the positive electrode active material.

### EXAMPLES E1 TO E6

In Examples E1 to E6, non-aqueous electrolyte secondary batteries of Examples E1 to E6 were fabricated in the same manner as in Example C1 except that the negative electrode mixtures used in producing the negative electrodes were changed from that of Example C1 described above.

In preparing the negative electrode mixture in each of Examples E1 to E6 here, the Li₄Ti₅O₁₂ was used as the negative electrode active material, the same graphitized vapor grown carbon fiber (C₀=6.74 Å) as that of Example A1 and the same artificial graphite (C₀=6.72 Å) as that of Comparative Example a4 were used as the conductive agents, and the poly(vinylidene fluoride) was used as the binder agent.

The mass ratios of the Li₄Ti₅O₁₂, graphitized vapor grown carbon fiber, artificial graphite, and poly(vinylidene fluoride) in the negative electrode mixtures were as follows: 85:10:0:5 in Example E1, 85:9:1:5 in Example E2, 85:8:2:5 in Example E3, 85:5:5:5 in Example E4, 85:2:8:5 in Example E5, and 85:1:9:5 in Example E6, respectively.

### COMPARATIVE EXAMPLES e1 AND e2

In Comparative Examples e1 and e2, non-aqueous electrolyte secondary batteries of Comparative Examples e1 and e2 were fabricated in the same manner as in Example C1 except that the negative electrode mixtures used in producing the negative electrodes were changed from that of Example C1.

In preparing the negative electrode mixture of Comparative Example e1 here, the mass ratio of the negative electrode active material Li₄Ti₅O₁₂, the same artificial graphite (C₀=6.72 Å) as that of Comparative Example a4 as the conductive agent, and poly(vinylidene fluoride) as the binder agent was 85:10:5. The same graphitized vapor grown carbon fiber (C₀=6.74 Å) as that of Example A1 was not added.

In preparing the negative electrode mixture of Comparative Example e2, the mass ratio of the negative electrode active material Li₄Ti₅O₁₂, the same graphitized vapor grown carbon fiber (C₀=6.74 Å) as that of Example A1, the same carbon black (C₀=7.00 Å) as that of Comparative Example a5, and poly(vinylidene fluoride) as the binder agent was 85:5:5:5.

Then, the internal resistances of the non-aqueous electrolyte secondary batteries after the constant voltage charge were measured also for the non-aqueous electrolyte secondary batteries of Examples E1 to E6 and Comparative Examples e1 and e2 in the same manner as in the case of the non-aqueous electrolyte secondary battery of Example C1. The results are shown in Table 7 below.

In addition, using 20 mg of each of the negative electrode mixtures prepared in Examples E1 to E6 and Comparative Examples e1 and e2, a force of 6 kN was applied thereto to shape it into in a pellet form of 5 mm diameter. The pellets were pressed with a 2-mm-diameter barstock, and the loads at which the pellets were broken were determined as their strengths. The results are shown in Table 7 below.

TABLE 7

| | Conductive agent in negative electrode | | | Internal | |
|---|---|---|---|---|---|
| | | | Weight | resistance | Strength |
| | Type | C₀(Å) | ratio | ( ) | (g) |
| Ex. E1 | Graphitized vapor grown carbon fiber | 6.74 | 10 | 705 | 94 |
| | Artificial graphite | 6.72 | 0 | | |
| Ex. E2 | Graphitized vapor grown carbon fiber | 6.74 | 9 | 725 | 105 |
| | Artificial graphite | 6.72 | 1 | | |
| Ex. E3 | Graphitized vapor grown carbon fiber | 6.74 | 8 | 780 | 168 |
| | Artificial graphite | 6.72 | 2 | | |
| Ex. E4 | Graphitized vapor grown carbon fiber | 6.74 | 5 | 835 | 215 |
| | Artificial graphite | 6.72 | 5 | | |
| Ex. E5 | Graphitized vapor grown carbon fiber | 6.74 | 2 | 978 | 350 |
| | Artificial graphite | 6.72 | 8 | | |
| Ex. E6 | Graphitized vapor grown carbon fiber | 6.74 | 1 | 1015 | 453 |
| | Artificial graphite | 6.72 | 9 | | |
| Comp. Ex. e1 | Graphitized vapor grown carbon fiber | 6.74 | 0 | 2750 | 565 |
| | Artificial graphite | 6.72 | 10 | | |
| Comp. Ex. e2 | Graphitized vapor grown carbon fiber | 6.74 | 5 | 5k or greater | 360 |
| | Carbon black | 7.00 | 5 | | |

The results demonstrate that the non-aqueous electrolyte secondary batteries of Examples E1 to E6, which employed graphitized vapor grown carbon fiber having a lattice constant C₀ of 6.8 Å or less and artificial graphite having a lattice constant C₀ of 6.8 Å or less as the conductive agents of the negative electrode, offered remarkably lower internal resistances than the non-aqueous electrolyte secondary battery of Comparative Example e1, which employed only the artificial graphite having a lattice constant C₀ of 6.8 Å or less, and than the non-aqueous electrolyte secondary battery of Comparative Example e2, which employed the graphitized vapor grown carbon fiber having a lattice constant C₀ of 6.8 Å or less and a carbon black having a lattice constant C₀ of greater than 6.8 Å.

In addition, when comparing among the non-aqueous electrolyte secondary batteries of Examples E1 to E6, as the mass ratio of the artificial graphite to the graphitized vapor grown carbon fiber was greater, the internal resistance increased and the strength of negative electrode became higher. Accordingly, in order to obtain a negative electrode with a sufficient strength, it is preferable that the mass ratio of the graphitized vapor grown carbon fiber and the artificial graphite be within the range of from 4:1 to 1:9. Moreover, in order to reduce the internal resistance and at the same time obtain a negative electrode with a sufficient strength, the mass ratio of the graphitized vapor grown carbon fiber and the artificial graphite be within the range of from 4:1 to 1:1.

Although the present invention has been fully described by way of examples, it is to be noted that various changes and modification will be apparent to those skilled in the art.

Therefore, unless otherwise such changes and modifications depart from the scope of the present invention, they should be construed as being included therein.

1. A non-aqueous electrolyte secondary battery comprising a positive electrode, a negative electrode, and a non-aqueous electrolyte, the negative electrode containing a conductive agent and a negative electrode active material comprising a lithium titanium oxide, wherein
the conductive agent in the negative electrode comprises graphitized vapor grown carbon fiber having a lattice constant C₀ along a stacking direction of from 6.7 Å to 6.8 Å, as determined by X-ray diffraction.

2. The non-aqueous electrolyte secondary battery according to claim 1, wherein the negative electrode active material is Li₄Ti₅O₁₂.

3. The non-aqueous electrolyte secondary battery according to claim 1, wherein the positive electrode active material is a lithium transition metal composite oxide represented by the formula LiMnₓNi_{y}Co_{z}O₂, where x+y+z=1, 0≦x≦0.5, 0≦y≦1, and 0≦z≦1, and the mass ratio of the negative electrode active material to the positive electrode active material is from 0.57 to 0.95.

4. The non-aqueous electrolyte secondary battery according to claim 3, wherein the positive electrode active material is LiCoO₂, and the mass ratio of the negative electrode active material to the positive electrode active material is from 0.57 to 0.85.

5. The non-aqueous electrolyte secondary battery according to claim 3, wherein the positive electrode active material is LiMn_{1/3}Ni_{1/3}Co_{1/3}O₂, and the mass ratio of the negative electrode active material to the positive electrode active material is from 0.70 to 0.95.

6. The non-aqueous electrolyte secondary battery according to claim 1, wherein the negative electrode comprises a negative electrode mixture containing the negative electrode active material, the conductive agent, and a binder agent, and the negative electrode mixture contains 3 mass % to 8 mass % of the graphitized vapor grown carbon fiber.

7. The non-aqueous electrolyte secondary battery according to claim 1, wherein the negative electrode contains another carbon material as a conductive agent other than the graphitized vapor grown carbon fiber, and said another carbon material also has a lattice constant C₀ along a stacking direction of from 6.7 Å to 6.8 Å, as determined by X-ray diffraction.

8. The non-aqueous electrolyte secondary battery according to claim 7, wherein the negative electrode active material is Li₄Ti₅O₁₂.

9. The non-aqueous electrolyte secondary battery according to claim 7, wherein the positive electrode active material is a lithium transition metal composite oxide represented by the formula LiMnₓNi_{y}Co_{z}O₂, where x+y+z=1, 0≦x≦0.5, 0≦y≦1, and 0≦z≦1, and the mass ratio of the negative electrode active material to the positive electrode active material is from 0.57 to 0.95.

10. The non-aqueous electrolyte secondary battery according to claim 9, wherein the positive electrode active material is LiCoO₂, and the mass ratio of the negative electrode active material to the positive electrode active material is from 0.57 to 0.85.

11. The non-aqueous electrolyte secondary battery according to claim 9, wherein the positive electrode active material is LiMn_{1/3}Ni_{1/3}Co_{1/3}O₂, and the mass ratio of the negative electrode active material to the positive electrode active material is from 0.70 to 0.95.

12. The non-aqueous electrolyte secondary battery according to claim 7, wherein the negative electrode comprises a negative electrode mixture containing the negative electrode active material, the conductive agent, and a binder agent, and the negative electrode mixture contains 3 mass % to 8 mass % of the graphitized vapor grown carbon fiber.
